(19) United States
(12) Patent Application Publication
(10) Pub. No.: US 2023/0259111 A1
(43) Pub. Date: Aug. 17, 2023

(54) ABNORMALITY DETECTION SYSTEM AND REFRIGERATOR, ABNORMALITY DETECTION METHOD, AND ABNORMALITY DETECTION PROGRAM

(71) Applicant: MITSUBISHI HEAVY INDUSTRIES THERMAL SYSTEMS, LTD., Tokyo (JP)

(72) Inventors: Yuki NISHIZAKI, Tokyo (JP); Satoshi NIKAIDO, Tokyo (JP); Noriyuki MATSUKURA, Tokyo (JP); Tatsuo ISHIGURO, Tokyo (JP); Katsuaki MORITA, Tokyo (JP); Ryuji IKEDA, Tokyo (JP); Hirotaka OKA, Tokyo (JP); Kenichi NAGAHARA, Tokyo (JP)

(73) Assignee: MITSUBISHI HEAVY INDUSTRIES THERMAL SYSTEMS, LTD., Tokyo (JP)

(21) Appl. No.: 18/010,630

(22) PCT Filed: Jul. 12, 2021
(86) PCT No.: PCT/JP2021/026149

§ 371 Date: Dec. 15, 2022

(30) Foreign Application Priority Data
Jul. 16, 2020 (JP) 2020-122016

(51) Int. Cl. G05B 23/02; F25B 49/02

(52) U.S. Cl. CPC G05B 23/0243; F25B 49/027; F25B 49/022

(57) ABSTRACT

The purpose of the present invention is to provide an abnormality detection system and refrigerator, an abnormality detection method, and an abnormality detection program which can improve the accuracy of abnormality detection. The abnormality detection system comprises: an acquisition unit which acquires driving data of a refrigerator (11); a creation unit which creates a model capable of estimating a prescribed driving state of the refrigerator (11) on the basis of the driving data, when the driving data is non-trained data; a determination unit which compares an estimation value of the driving state, the estimation value being estimated by the model, with an actual measurement value corresponding to the driving state, and determines whether the driving data is an outlier; and an abnormality detection unit which performs, on the basis of the model, abnormality detection on the refrigerator (11), when the driving data is not determined to be the outlier.

### TECHNICAL FIELD

The present disclosure relates to an abnormality detection system and a chiller, an abnormality detection method, and an abnormality detection program.

### BACKGROUND ART

A chiller is used in a heat source system (for example, PTL 1). When an abnormality occurs in the chiller, it may affect other equipment, thereby a driving state monitoring is performed.

### CITATION LIST

### Patent Literature

[PTL 1] Japanese Patent No. 5244420

### SUMMARY OF INVENTION

### Technical Problem

When using a model (a pseudo chiller model) for abnormality detection of a chiller, it is necessary to create a model based on a normal driving state of the chiller. When the created model is based on driving data that is not the normal driving state of the chiller, the reproducing accuracy of the model may decrease, and the abnormality detection may not be performed correctly. The decrease of the abnormality detection accuracy when using the above-mentioned model may occur not only in chillers.

The present disclosure has been made in view of such circumstances, and the purpose of the present invention is to provide an abnormality detection system and a chiller, an abnormality detection method, and an abnormality detection program that can improve the accuracy of abnormality detection.

### Solution to Problem

An abnormality detection system according to a first aspect of the present disclosure includes: an acquisition unit that acquires driving data of a target device; a model calculation unit that creates a model capable of estimating a predetermined driving state of the target device based on the driving data, when the driving data is non-trained data; a determination unit that compares an estimation value of the driving state, which is estimated by using the model, with an actual measurement value corresponding to the driving state and that determines whether the driving data is an outlier value; and an abnormality detection unit that performs abnormality detection on the target device based on the model, when the driving data is determined not to be the outlier value.

An abnormality detection method according to a second aspect of the present disclosure includes: a step of acquiring driving data of a target device; a step of creating a model capable of estimating a predetermined driving state of the target device based on the driving data, when the driving data is non-trained data; a step of comparing an estimation value of the driving state, which is estimated by using the model, with an actual measurement value corresponding to the driving state and determining whether the driving data is an outlier value; and a step of performing abnormality detection on the target device based on the model, when the driving data is determined not to be the outlier value.

An abnormality detection program according to a third aspect of the present disclosure for causing a computer to execute: a process of acquiring driving data of a target device; a process of creating a model capable of estimating a predetermined driving state of the target device based on the driving data, when the driving data is non-trained data; a process of comparing an estimation value of the driving state, which is estimated by using the model, with an actual measurement value corresponding to the driving state and determining whether the driving data is an outlier value; and a process of performing abnormality detection on the target device based on the model, when the driving data is determined not to be the outlier value.

### Advantageous Effects of Invention

According to the present disclosure, it is possible to obtain an effect that the accuracy of abnormality detection can be improved.

### BRIEF DESCRIPTION OF DRAWINGS

FIG. 1 is a diagram showing a schematic configuration of a heat source system according to an embodiment of the present disclosure.

FIG. 2 is a diagram showing a specific configuration of a centrifugal chiller according to the embodiment of the present disclosure.

FIG. 3 is a diagram showing an example of a hardware configuration of an abnormality detection system according to the embodiment of the present disclosure.

FIG. 4 is a functional block diagram showing functions included in the abnormality detection system according to the embodiment of the present disclosure.

FIG. 5 is a diagram showing an example of an allowable error range according to the embodiment of the present disclosure.

FIG. 6 is a diagram showing a flowchart of an abnormality detection process according to the embodiment of the present disclosure.

FIG. 7 is a diagram showing a flowchart of a driving mode specification process according to the embodiment of the present disclosure.

FIG. 8 is a diagram showing a flowchart of the driving mode specification process according to the embodiment of the present disclosure.

### DESCRIPTION OF EMBODIMENTS

An embodiment of an abnormality detection system and a chiller, an abnormality detection method, and an abnormality detection program according to the present disclosure will be described below with reference to the drawings. In the present embodiment, a chiller will be described as an example of an abnormality detection target device, but the target device is not limited to a chiller and can be various devices. For example, the present embodiment can be applied to a device such as a generator.

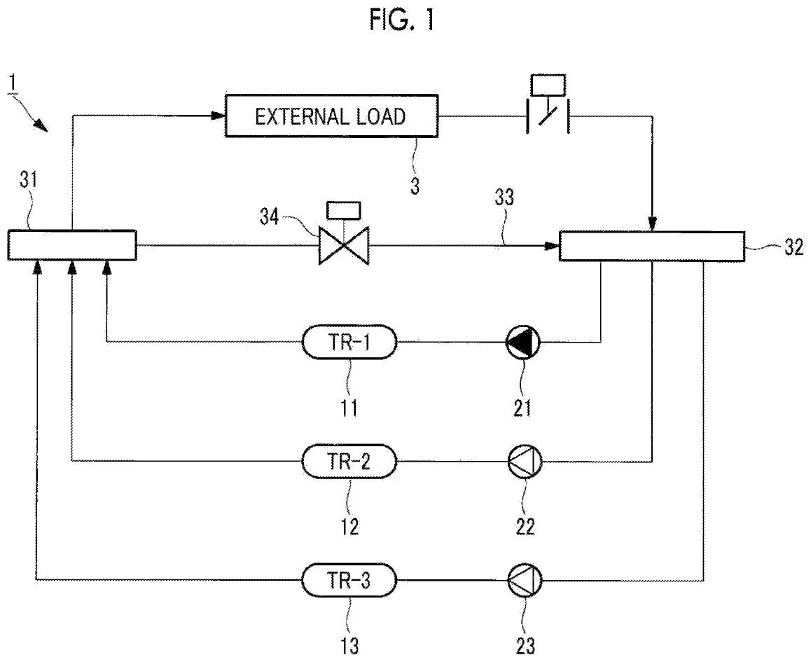

FIG. 1 is a diagram showing a schematic configuration of a heat source system 1 according to an embodiment of the present disclosure. The heat source system 1 is installed, for example, in a building or factory equipment. The heat source system 1 includes a centrifugal chiller 11, a centrifugal chiller 12, and a centrifugal chiller 13, which apply cooling with respect to chilled water supplied to a load 3 such as an air conditioner or a fan coil. The centrifugal chiller 11, the centrifugal chiller 12, and the centrifugal chiller 13 are installed in parallel with respect to the load 3. The number of installed centrifugal chillers is not limited to three.

A chilled water pump 21, a chilled water pump 22, and a chilled water pump 23 for pumping the chilled water are installed respectively on the upstream side of each of the centrifugal chillers 11, 12, and 13 as seen from the flow of the chilled water. The chilled water is sent to the centrifugal chillers 11, 12, and 13 from a return header 32 by the chilled water pump 21, the chilled water pump 22, and the chilled water pump 23.

A supply header 31 is configured such that the chilled water that is obtained in each of the centrifugal chillers 11, 12, and 13 is collected. The chilled water that is collected in the supply header 31 is supplied to the load 3. The chilled water that is heated by air conditioning or the like in the load 3 is sent to the return header 32. The chilled water is branched at the return header 32 and sent to each of the centrifugal chillers 11, 12, and 13.

A bypass pipe 33 having a bypass valve 34 is provided between the supply header 31 and the return header 32.

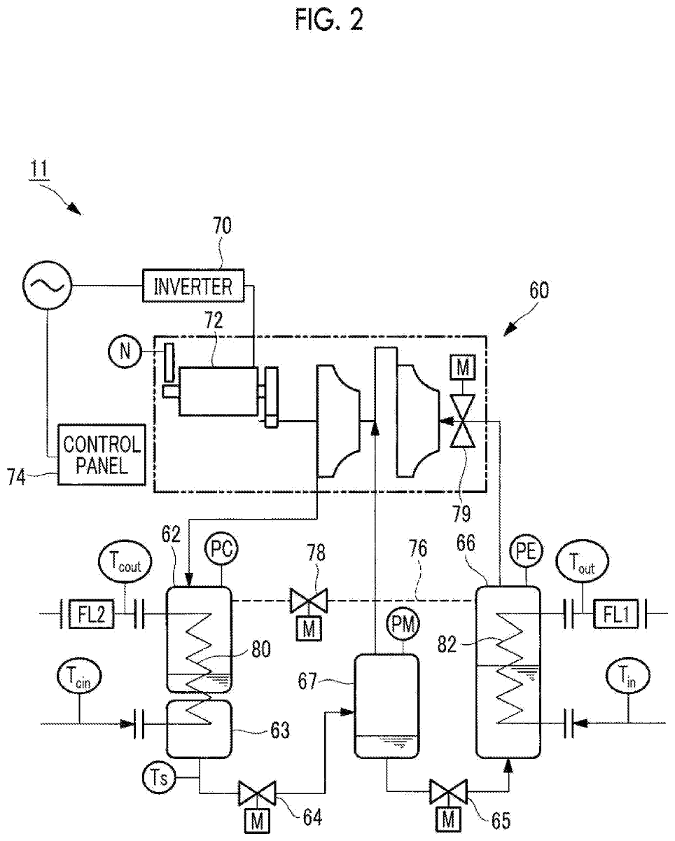

The technique of the present disclosure is applicable regardless of a cycle of the centrifugal chiller. FIG. 2 shows a configuration of a two-stage compression two-stage expansion sub cooling cycle as an example of a centrifugal chiller. FIG. 2 is a diagram showing an example of a specific configuration of the centrifugal chillers 11, 12, and 13. Although FIG. 2 shows a specific configuration of the centrifugal chiller 11, the centrifugal chiller 12 or the centrifugal chiller 13 also has the same configuration. A case in which antifreeze (brine) is used as a heat medium will be described, but the heat medium is not limited to brine. The configuration in FIG. 2 is an example, and other configurations can be applied as long as a chiller is used. An abnormality detection system 50, which will be described later, is applied to the centrifugal chiller.

The centrifugal chiller 11 in FIG. 2 has a configuration of a two-stage compression two-stage expansion sub cooling cycle. The configuration shown in FIG. 2 is an example, and other configurations can be adopted. That is, a configuration is not limited to the configuration in FIG. 2. The centrifugal chiller 11 includes a compressor 60 that compresses a refrigerant, a condenser 62 for condensing a high-temperature and high-pressure gas refrigerant compressed by the compressor 60, a sub cooler 63 that applies supercooling with respect to a liquid refrigerant condensed in the condenser 62, a high-pressure expansion valve (an expansion valve) 64 that expands the liquid refrigerant from the sub cooler 63, an economizer 67 that is connected to the high-pressure expansion valve 64 and that is connected to an intermediate stage of the compressor 60 and a low-pressure expansion valve (an expansion valve) 65, and an evaporator 66 that evaporates the liquid refrigerant expanded by the low-pressure expansion valve 65.

The compressor 60 is a two-stage centrifugal compressor and is driven by an electric motor 72 whose rotational speed is controlled by variable frequency drives 70. An output of the variable frequency drives 70 is controlled by a control panel 74. A refrigerant intake port of the compressor 60 is provided with an inlet guide vane (hereinafter referred to as an “IGV”) 79 for controlling the flow rate of the intake refrigerant, and capacitance control of the centrifugal chiller 11 is possible.

The condenser 62 is provided with a condensed refrigerant pressure sensor PC for measuring the condensed refrigerant pressure.

The sub cooler 63 is provided on a downstream side of the flow of the refrigerant of the condenser 62 to apply supercooling with respect to the condensed refrigerant. A temperature sensor Ts for measuring the temperature of the refrigerant after the supercooling is provided immediately after the sub cooler 63 on the downstream side of the flow of the refrigerant.

Condenser tubes 80 are inserted through the condenser 62 and the sub cooler 63 for cooling the condenser 62 and the sub cooler 63. A flow rate of cooling water is measured by a flow meter FL2, the temperature of a cooling water outlet is measured by a temperature sensor Tcout, and the temperature of a cooling water inlet is measured by a temperature sensor Tcin. The cooling water is configured to be guided to the condenser 62 and the sub cooler 63 again after the heat is exhausted to the outside in a cooling tower (not shown).

The economizer 67 is provided with a pressure sensor PM for measuring the intermediate pressure.

The evaporator 66 is provided with a pressure sensor PE for measuring the evaporation pressure. The chilled water at the rated temperature is obtained by absorbing heat in the evaporator 66. The evaporator tubes 82 for cooling the chilled water supplied to the load 3 are inserted through the evaporator 66. A flow rate of the chilled water is measured by a flow meter FL1, the temperature of a chilled water outlet is measured by a temperature sensor Tout, and the temperature of a chilled water inlet is measured by a temperature sensor Tin.

A hot gas bypass pipe 76 is provided between a gas phase portion of the condenser 62 and a gas phase portion of the evaporator 66. A hot gas bypass valve 78 for controlling the flow rate of the refrigerant flowing through the hot gas bypass pipe 76 is provided. By adjusting a hot gas bypass flow rate with the hot gas bypass valve 78, it is possible to control the capacitance in a very small region where control is not sufficient with the IGV 79. That is, when the load is small (when there is no target to cool or the like), it is possible to prevent the temperature (pressure) of the evaporator 66 from dropping too much or the liquid refrigerant from being sucked into the compressor 60, thereby the refrigeration circuit can be stabilized.

The abnormality detection system 50 performs abnormality detection on the chiller. As will be described later, abnormality determination is performed by using a model (a pseudo chiller model) that is capable of estimating the normal driving state of the chiller. In the present embodiment, a case of using a mathematical model (a mathematical model in which an objective variable is represented with an explanatory variable and a coefficient) will be described, but the model is not limited to a mathematical formula.

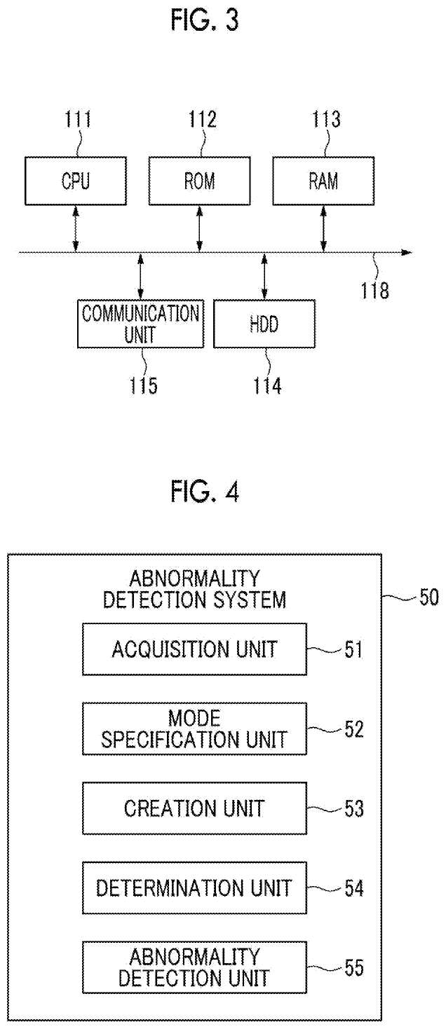

FIG. 3 is a diagram showing an example of a hardware configuration of the abnormality detection system 50 according to the present embodiment.

As shown in FIG. 3, the abnormality detection system 50 is a computer system (a calculation system), for example, and includes a CPU 111, a read only memory (ROM) 112 for storing a program executed by the CPU 111, a random access memory (RAM) 113 for functioning as a work area when executing each program, a hard disk drive (HDD) 114 as a mass storage device, and a communication unit 115 for the connection to a network or the like. A solid state drive (SSD) may be used as a mass storage device. Each of these units is connected via a bus 118.

The abnormality detection system 50 may include an input unit such as a keyboard or a mouse, and a display unit such as a liquid crystal display device for displaying data.

A storage medium for storing a program and the like executed by the CPU 111 is not limited to the ROM 112. For example, other auxiliary storage devices such as a magnetic disk, a magneto-optical disk, and a semiconductor memory may be used.

A procedure of a series of processes for realizing various functions described later is recorded in the hard disk drive 114 or the like in the form of a program, and various functions described later are realized by reading and loading the program to the RAM 113 or the like and executing information processing and arithmetic processing by the CPU 111. The program may be installed in the ROM 112 or other storage media in advance, the program may be provided in a state of being stored in a computer-readable storage medium, or the program may be distributed via wired or wireless communication means. Examples of the computer-readable storage medium include a magnetic disk, a magneto-optical disk, a CD-ROM, a DVD-ROM, a semiconductor memory, and the like.

FIG. 4 is a functional block diagram showing functions included in the abnormality detection system 50. As shown in FIG. 4, the abnormality detection system 50 includes an acquisition unit 51, a mode specification unit 52, a model calculation unit 53, a determination unit 54, and an abnormality detection unit 55.

The acquisition unit 51 acquires driving data of the chiller. The driving data is a predetermined parameter value that represents the driving state of the chiller. Therefore, the chiller is provided with measurement equipment or the like in advance to be capable of acquiring predetermined driving data. A command value or the like for the chiller can be used as well as the measured value as long as the value indicates the driving state.

The driving data includes, for example, information about the degree of opening of each valve, evaporation saturation temperature, chilled water outlet temperature, evaporator pressure (evaporation pressure), economizer pressure (intermediate pressure), condenser pressure (condensed refrigerant pressure), a chiller load factor, or the like. The driving data is appropriately selected according to the configuration of the chiller, the model of the chiller to be described later, and the like, and is not limited to the above.

A plurality of driving modes are set in advance, and the mode specification unit 52 specifies the driving mode of the chiller based on the driving data. The driving mode is a mode in which the driving state of the chiller is classified into a plurality of states.

For example, the driving mode can be an inactive state, an idle state, a low load state, an active state, and a high load state. At least any two of the inactive state, the idle state, the low load state, the active state, and the high load state may be used as the driving state. That is, the plurality of driving modes are set in advance, and one driving mode is selected based on the driving data.

The inactive state is a stop state. That is, the inactive state is a state in which the chiller is not being driven and is stopped.

The idle state is an idling state. That is, the idle state is a state in which the compressor 60 is not operating due to the light load. In other words, the idle state is a standby state for operation.

The low load state is a state in which the chiller is being driven (the compressor 60 is being operated), and the hot gas bypass valve 78, which makes some of gas that is compressed by a compressor 60 bypass to an inlet side of the compressor 60, is open. That is, the low load state is a state in a case in which a load state is low while the chiller is being driven and the hot gas bypass valve 78 is open.

The active state is a state in which the chiller is being driven and the hot gas bypass valve 78 is closed. That is, the active state is a state in a case in which the hot gas bypass valve 78 is closed because the load state is not low while the chiller is being driven.

The high load state is a state in which the chiller is being driven, the hot gas bypass valve 78 is closed, and the target temperature of the chilled water output from the chiller is higher than 0° C. That is, the high load state is a state in a case in which the hot gas bypass valve 78 is closed because the load state is not low while the chiller is being driven, and is a state in which the target temperature of the chilled water output from the chiller is higher than 0° C. Particularly, the high load state is a driving state unique to a brine machine. When the brine is used as the heat medium, the target temperature of the chilled water can be set to 0° C. or lower. Therefore, the brine machine can adopt a two-point specification. In the two-point specification, two target temperatures are set and the two temperatures can be switched. For example, the two target temperatures of −5° C. and 7° C. are set in two-point. The chiller is driven with the target temperature of −5° C. during the normal driving, but when the load increases, the target temperature is switched to 7° C. and the chiller is driven. That is, the high load state is a driving state unique to a brine machine.

The plurality of driving modes are set in this manner, and the mode specification unit 52 specifies the driving mode corresponding to the current driving state of the chiller based on the driving data. Since the driving data is data representing the current driving state of the chiller, it is possible to specify the corresponding driving mode. Regarding the specification of the driving mode, the driving mode may be distinguished based on the acquired driving data, or a predetermined state quantity (a value capable of distinguishing the driving mode) is calculated based on the acquired driving data and the driving mode may be distinguished based on the state quantity for easy distinguishing.

A specific example of a specification method of the driving mode will be described later. When the driving mode is specified, the specified driving mode is output to the model calculation unit 53.

The driving mode may be classified based on the load state. For example, the driving mode may be a stop state, an idling state, a low load state in which a load state is less than a first predetermined value, a driving state in which a load state is equal to or greater than the first predetermined value and less than a second predetermined value that is set to a value greater than the first predetermined value, and a high load state (an overload state) in which a load state is equal to or greater than the second predetermined value. When the driving mode is set in this way, at least any two of the above states may be used. That is, the plurality of driving modes are set in advance, and one driving mode is selected based on the driving data.

When the acquired driving data is non-trained data, the model calculation unit 53 creates a model capable of estimating a predetermined driving state of the chiller based on the driving data. Specifically, already trained driving data (hereinafter referred to as “trained data”) is acquired in accordance with the specified driving mode. The trained data is data in which learning is already performed on the model corresponding to each driving mode (reflection to the model is completed), and the trained data is stored for each driving mode.

Therefore, the model calculation unit 53 acquires the trained data corresponding to the specified driving mode and compares the trained data with the newly acquired driving data. A learning target range is set in the model. The learning target range is a range of the driving data used for training the model. The learning target range is divided into predetermined small regions (for example, 50 regions). For example, for the learning target range, the set full scale is equally divided by the set number. A predetermined number (for example, 20) of data can be stored in each small region. That is, the trained data used for training the model is counted as the number of data in the corresponding small region, and when the number of trained data in the small region reaches a predetermined number, the small region becomes a trained region. A small region in which the number of trained data has not reached the predetermined number is a non-trained region.

The model calculation unit 53 acquires the trained data corresponding to the driving mode and determines whether there is a non-trained region in the driving mode. When there is a non-trained region, it is determined whether the newly acquired driving data is data corresponding to the non-trained region.

When the newly acquired driving data is data corresponding to the non-trained region, it is determined whether the newly acquired driving data is to be used for a first learning. That is, it is determined whether the newly acquired data and the trained data of the non-trained region match. As a result, it is determined that the newly acquired data is data that has not yet been reflected in the model in the current driving mode.

When the newly acquired driving data is to be used for the first learning, the driving data is reflected (fitted) in the model. In this way, the model calculation unit 53 creates (updates) the model in accordance with the specified driving mode.

When the model is created (updated) in the model calculation unit 53, processing in the determination unit 54 is performed.

The determination unit 54 compares an estimation value of the driving state, which is estimated by using the model, with an actual measurement value corresponding to the driving state, and determines whether the driving data is an outlier value. The estimation value and the actual measurement value are values corresponding to the same parameters.

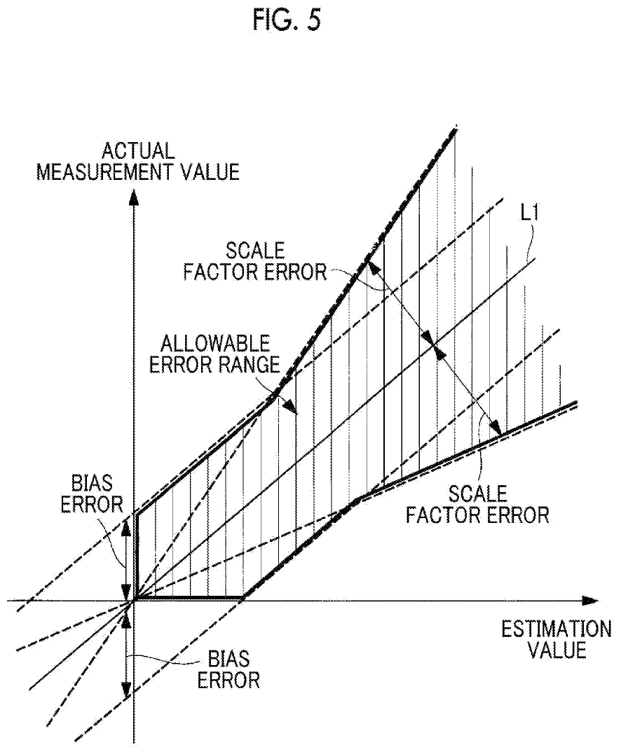

Specifically, the determination unit 54 determines whether the driving data is an outlier value based on an error between the estimation value and the actual measurement value and an allowable error range. FIG. 5 is a diagram showing an example of the allowable error range. In FIG. 5, the vertical axis is set to the actual measurement value (the sensor value), the horizontal axis is set to the estimation value (the model predicted value), and the allowable error range is set in a plane region with the actual measurement value and the estimation value as respective axes. Since the vertical axis is set to the actual measurement value and the horizontal axis is set to the estimation value, when the actual measurement value and estimation value match, a point where the actual measurement value and the estimation value are combined is positioned on a plane with a 45° inclination line (L1 in FIG. 5). However, since there are measurement errors in the measurement equipment or the like, the allowable error range is set such that the 45° inclination line (L1 in FIG. 5) is included in consideration of a scale factor error (an inclination error) and a bias error (an intercept error). That is, the allowable error range is set based on the measurement error of the actual measurement value.

In this way, the determination unit 54 determines whether the point on the plane, which is represented based on the estimation value and the actual measurement value, is within the allowable error range. When the point on the plane, which is represented based on the estimation value and the actual measurement value, is not within the allowable error range, since there is a high possibility that the newly acquired driving data, which is reflected in the model, does not indicate the driving state in the normal state, the driving data is set to an outlier value (an abnormality value). For example, when the measurement equipment for acquiring the driving data malfunctions or when the driving state of the chiller is in an abnormal state, the driving data becomes an outlier value.

When the driving data is an outlier value, and the driving data is reflected in the model, the model may not be able to indicate the driving state of the chiller in a normal state. Therefore, the abnormality determination is performed by using a model (already created model) in which the newly acquired driving data is not reflected when the driving data is an outlier value, and the abnormality determination is performed by using a model in which the newly acquired driving data is reflected when the driving data is not the outlier value.

When it is determined that the driving data is not an outlier value, the abnormality detection unit 55 performs the abnormality detection of the chiller based on the model (the model in which the driving data is reflected). The abnormality detection unit 55 performs the abnormality detection of the chiller based on the model corresponding to the specified driving mode.

The abnormality detection unit 55 calculates a deviation between the driving state estimated by using the model and the actual measurement value of the driving state, and performs the abnormality detection. For example, when the deviation is equal to or greater than a threshold value, it is determined that an abnormality has occurred in the chiller. The abnormality detection may be performed based on the degree of abnormality (an abnormality value indicating how abnormal it is) based on the driving state estimated by using the model and the actual measurement value of the driving state. When it is possible to estimate a plurality of driving states by using the model, the abnormality detection may be performed by calculating the abnormality values in accordance with each driving state and integrating the abnormality values (for example, by calculating the sum of the abnormality values).

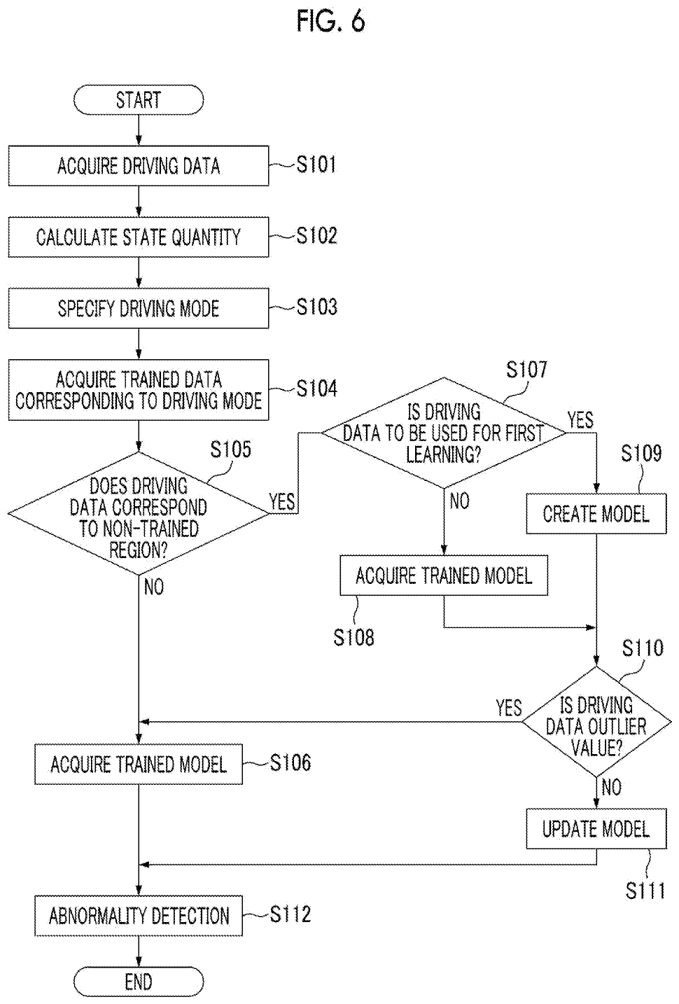

Next, an example of an abnormality detection process performed by the above-mentioned abnormality detection system 50 will be described with reference to FIG. 6. FIG. 6 is a flowchart showing an example of a procedure of the abnormality detection process according to the present embodiment. The flow shown in FIG. 6 is repeatedly executed at a predetermined control cycle, for example, in a case in which monitoring of the chiller is started.

First, the driving data is acquired from the chiller (S101).

Next, the state quantity is calculated based on the driving data (S102). The state quantity is a value that is calculated based on the driving data and that is capable of being used to distinguish the driving mode, and S102 may be omitted when the driving mode can be distinguished using the driving data as it is.

Next, the specification of the driving mode is performed (S103). In S103, the driving mode corresponding to the current driving state of the chiller is specified from among the plurality of driving modes (the inactive state, the idle state, the low load state, the active state, and the high load state) set in advance.

Next, the trained data corresponding to the specified driving mode is acquired (S104). The driving data that is reflected in the model is stored as the trained data for each driving mode, and the corresponding trained data is acquired by specifying the driving mode.

Next, it is determined whether the newly acquired driving data is data corresponding to the non-trained region (S105). When the newly acquired driving data is not data corresponding to the non-trained region (the determination in S105 is NO), a trained model is acquired (S106). The trained model acquired in S106 is a model created when the flow in FIG. 6 was previously executed, thereby the newly acquired driving data is not reflected.

When the newly acquired driving data is data corresponding to the non-trained region (the determination in S105 is YES), it is determined whether the newly acquired driving data is to be used for the first learning (S107). When the newly acquired driving data is not to be used for the first learning (the determination in S107 is NO), a trained model is acquired (S108).

When the newly acquired driving data is to be used for the first learning (the determination in S107 is YES), a model is created by reflecting the newly acquired driving data (S109). That is, in S109, the model corresponding to the driving mode is updated based on the newly acquired driving data.

Next, it is determined whether the newly acquired driving data is an outlier value by comparing the estimation value of the driving state, which is estimated by using the model, with the actual measurement value corresponding to the driving state (S110). When the newly acquired driving data is an outlier value (the determination in S110 is YES), S106 is executed.

When the newly acquired driving data is not an outlier value (the determination in S110 is NO), the model in which the newly acquired driving data is reflected (the model created in S109) is set as the model to be used for the abnormality detection, and the model is updated. (S111).

Thereafter, the abnormality detection is performed based on the model (S112). Regarding the abnormality detection, for example, the abnormality detection may be performed based on the degree of abnormality (an abnormality value indicating how abnormal it is) based on the driving state estimated by using the model and the actual measurement value of the driving state. When it is possible to estimate a plurality of driving states by using the model, the abnormality detection may be performed by calculating the abnormality values in accordance with each driving state and integrating the abnormality values (for example, by calculating the sum of the abnormality values).

By performing the process in this manner, the abnormality detection is performed in accordance with the driving mode. The abnormality detection can be performed by using a model in which the driving data that becomes an outlier value is not reflected.

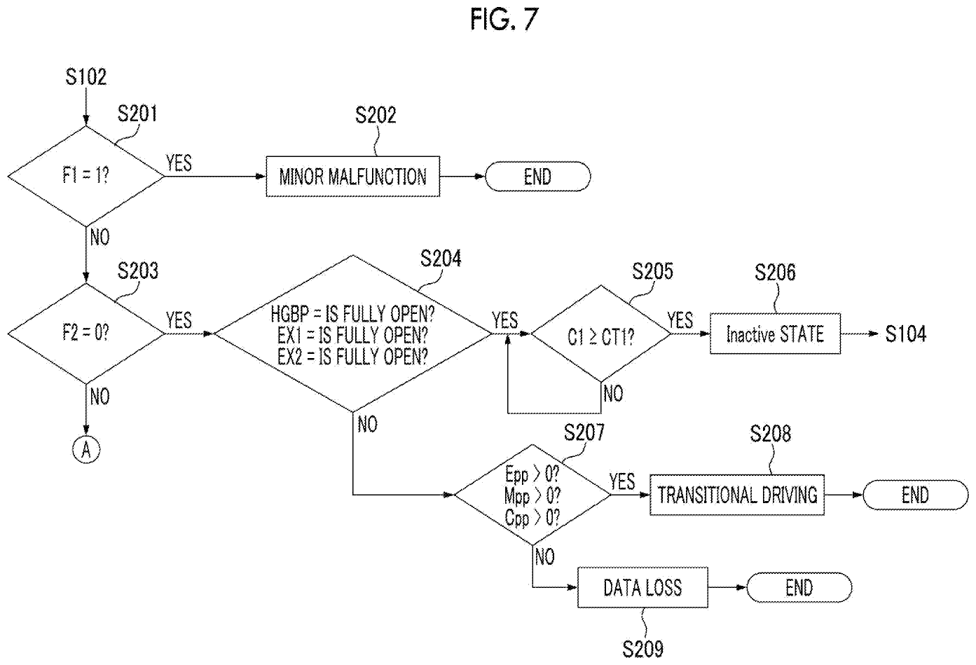

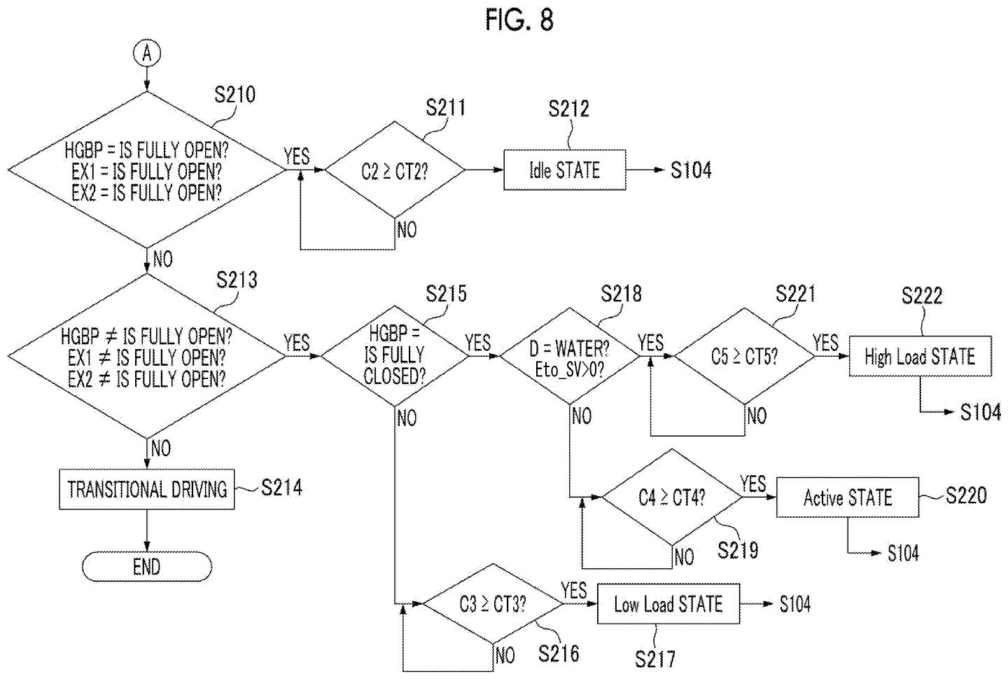

Next, an example of a driving mode specification process performed by the above-mentioned abnormality detection system 50 will be described with reference to FIGS. 7 and 8. FIGS. 7 and 8 are flowcharts showing an example of a procedure of the driving mode specification process according to the present embodiment. The flows shown in FIGS. 7 and 8 are started, for example, when S103 is executed. FIG. 8 shows the continuation of the flow in FIG. 7. It is assumed that the driving data includes information necessary for executing the flow in FIG. 7.

First, it is determined whether a minor malfunction flag F1 is 1 (S201). For example, the minor malfunction flag F1 is set to 1 by the determination process for a minor malfunction.

When the minor malfunction flag F1 is 1 (the determination in S201 is YES), it is assumed that a minor malfunction has occurred (S202), and the process is ended. When the process is ended, the processes after S104 are not executed.

When the minor malfunction flag F1 is not 1 (the determination in S201 is NO), it is determined whether a flag F2 indicating that the chiller is being driven is 0 (S203). The flag F2 becomes 1 when the chiller is being driven.

When the flag F2 indicating that the chiller is being driven is 0 (the determination in S203 is YES), it is determined whether the degree of opening HGBP of the hot gas bypass valve 78 is fully open, the degree of opening EX1 of the low-pressure expansion valve 65 is fully open, and the degree of opening EX2 of the high-pressure expansion valve 64 is fully open (S204). When the determination in S204 is YES, it is determined whether a mode continuation time series number C1 is equal to or greater than a threshold value CT1 (S205). The mode continuation time series number C1 is a count value indicating how many times the same driving mode continues. Mode continuation time series numbers C2 to C5, which will be described later, are the same as C1.

When the mode continuation time series number C1 is equal to or greater than the threshold value CT1 (the determination in S205 is YES), the driving mode is specified as the inactive state (S206), and S104 is executed.

When the mode continuation time series number C1 is not equal to or greater than the threshold value CT1 (the determination in S205 is NO), S205 is executed again. That is, the mode continuation time series number C1 increases with time, and S205 is executed until the determination is made to YES.

When the determination in S204 is NO, it is determined whether the evaporator pressure (Eₚₚ) is greater than 0, the economizer pressure (Mₚₚ) is greater than 0, and the condenser pressure (Cₚₚ) is greater than 0 (S207). When the determination in S207 is YES, it is assumed that the transitional driving is being performed (S208), and the process is ended. When the process is ended, the processes after S104 are not executed. The transitional driving is in a state in the middle of changing to one of the driving modes.

When the determination in S207 is NO, it is assumed that there is data loss (S209), and the process is ended. When the process is ended, the processes after S104 are not executed. The data loss is in a state in which the required driving data may be empty.

When the flag F2 indicating that the chiller is being driven is not 0 (that is, 1) (the determination in S203 is NO), it is determined whether the degree of opening HGBP of the hot gas bypass valve 78 is fully open, the degree of opening EX1 of the low-pressure expansion valve 65 is fully open, and the degree of opening EX2 of the high-pressure expansion valve 64 is fully open (S210). When the determination in S210 is YES, it is determined whether the mode continuation time series number C2 is equal to or greater than a threshold value CT2 (S211). When the determination in S210 is YES, it is estimated that the compressor 60 is not being operated, and it can be determined that there is a possibility of the idle state. The specification method of the idle state is not limited to the determination in S210, and other methods may be adopted.

When the mode continuation time series number C2 is equal to or greater than the threshold value CT2 (the determination in S211 is YES), the driving mode is specified as the idle state (S212), and S104 is executed.

When the mode continuation time series number C2 is not equal to or greater than the threshold value CT2 (the determination in S211 is NO), S211 is executed again. That is, the mode continuation time series number C2 increases with time, and S211 is executed until the determination is made to YES.

When the determination in S210 is NO, it is determined whether the degree of opening HGBP of the hot gas bypass valve 78 is not fully open, the degree of opening EX1 of the low-pressure expansion valve 65 is not fully open, and the degree of opening EX2 of the high-pressure expansion valve 64 is not fully open (S213). When the determination in S213 is NO, it is assumed that the transitional driving is being performed (S214), and the process is ended. When the process is ended, the processes after S104 are not executed.

When the determination in S213 is YES, it is determined whether the degree of opening HGBP of the hot gas bypass valve 78 is fully closed (S215). When the degree of opening HGBP of the hot gas bypass valve 78 is not fully closed (the determination in S215 is NO), it is determined whether a mode continuation time series number C3 is equal to or greater than a threshold value CT3 (S216).

When the mode continuation time series number C3 is equal to or greater than the threshold value CT3 (the determination in S216 is YES), the driving mode is specified as the low load state (S217), and S104 is executed.

When the mode continuation time series number C3 is not equal to or greater than the threshold value CT3 (the determination in S216 is NO), S216 is executed again. That is, the mode continuation time series number C3 increases with time, and S216 is executed until the determination is made to YES.

When the degree of opening HGBP of the hot gas bypass valve 78 is fully closed (the determination in S215 is YES), it is determined whether the type of the medium of the chilled water B is not water and the set chilled water outlet temperature (the target temperature of the chilled water) Eₜₒ_SV is equal to or higher than 0° C. (S218). When the determination in S218 is NO, it is determined whether a mode continuation time series number C4 is equal to or greater than a threshold value CT4 (S219).

When the mode continuation time series number C4 is equal to or greater than the threshold value CT4 (the determination in S219 is YES), the driving mode is specified as the active state (S220), and S104 is executed.

When the mode continuation time series number C4 is not equal to or greater than the threshold value CT4 (the determination in S219 is NO), S219 is executed again. That is, the mode continuation time series number C4 increases with time, and S219 is executed until the determination is made to YES.

When the determination in S218 is YES, it is determined whether a mode continuation time series number C5 is equal to or greater than a threshold value CT5 (S221).

When the mode continuation time series number C5 is equal to or greater than the threshold value CT5 (the determination in S221 is YES), the driving mode is specified as the high load state (S222), and S104 is executed.

When the mode continuation time series number C5 is not equal to or greater than the threshold value CT5 (the determination in S221 is NO), S221 is executed again. That is, the mode continuation time series number C5 increases with time, and S221 is executed until the determination is made to YES.

As described above, the driving mode is specified. Particularly, although the above flow shows a case in which the driving mode is specified based on the information about the degree of opening of the valve provided in the chiller, the flow is not limited to the above flow as long as each driving mode can be distinguished.

Next, a specific example of the model will be described.

As described above, the model is a pseudo model capable of estimating a predetermined driving state of the chiller. Therefore, various models can be adopted in accordance with the driving state of the target of the abnormality detection. As for the method of the model, if the predetermined driving state of the chiller can be estimated, it is possible to use models of various expression formats such as a mathematical model.

For example, when the model of the chiller is represented by a mathematical model, it is represented using an explanatory variable, an objective variable, and a coefficient. Specifically, assuming that the evaporator pressure is set to the driving state (the objective variable) to be estimated, the model corresponding to the driving mode of the inactive state is represented by the following Equation (1).

Eₚₚ=p′₀+p′₁\sqrt{Mₚₚ×Cₚₚ} (1)

In Equation (1), Eₚₚ is the evaporator pressure, Mₚₚ is the economizer pressure, and Cₚₚ is the condenser pressure. Each of p₀′ and p₁′ indicates a coefficient. That is, in Equation (1), a model that is adapted to the driving data is generated by recursively determining (to be fitted) the coefficients p₀′ and p₁′ using Eₚₚ, Mₚₚ, and Cₚₚ as the driving data. By inputting Mₚₚ and Cₚₚ, it becomes possible to estimate the evaporator pressure as Eₚₚ.

The model corresponding to each of the idle state, the low load state, the active state, and the high load state is represented as the following Equations (2) and (3).

Eₚₚ=p₂+p₃×f(T_{E}) (2)

TT_{E}=E_{tO}+p₀−p₁×L (3)

In Equations (2) and (3), TT_{E} is evaporation saturation temperature, Eₜₒ is chilled water outlet temperature, L is a chiller load factor, and f(TT_{E}) is a function for obtaining the saturated evaporation pressure from the evaporation saturation temperature. Each of p₀, p₁, p₂, and p₃ is a coefficient.

That is, in Equations (2) and (3), a model that is adapted to the driving data is generated by recursively determining (to be fitted) the coefficients p₀, p₁, p₂, and p₃ using Eₚₚ, TT_{E}, Eₜₒ, and L as the driving data.

Since the fitting is performed in accordance with the driving data corresponding to each of the driving modes, p₀, p₁, p₂, and p₃ become values corresponding to each of the driving modes. That is, since p₀, p₁, p₂, and p₃ differ for each driving mode of the idle state, the low load state, the active state, and the high load state in Equations (2) and (3), a model is generated in accordance with each driving mode.

Thereafter, by inputting TT_{E}, Eₜₒ, and L to Equations (2) and (3), which are based on the coefficients corresponding to the driving mode, it becomes possible to estimate the evaporator pressure as Eₚₚ.

Although Equations (1) to (3) show an example of the model, the model in the present embodiment is not limited to the above equations.

In the present embodiment, although the process is performed in accordance with each driving mode, it is also possible to create a model and perform a process (for example, outlier value determination) without distinguishing the driving mode.

As described above, according to the abnormality detection system and the chiller, the abnormality detection method, and the abnormality detection program of the present embodiment, the model is created based on the driving data when the driving data, which is acquired from the chiller, is non-trained data. Thereafter, it is determined whether the driving data used to create the model is an outlier value (an abnormality value) by comparing the estimation value of the driving state, which is estimated by using the created model, and the actual measurement value. Thereafter, when it is determined that the driving data is not an outlier value, the abnormality detection of the chiller is performed by using the created model. As a result, when non-trained driving data is acquired, it is possible to determine whether the driving data is an outlier value, and it is possible to perform the abnormality detection by using a model based on the driving data that is not an outlier value. Therefore, the accuracy of the abnormality detection can be improved.

The driving mode of the chiller is specified based on the driving data, and a model is created in accordance with the specified driving mode and is used for the abnormality detection. Therefore, it is possible to improve the accuracy of the abnormality detection.

The present disclosure is not limited to the above-mentioned embodiment, and various modifications can be made without departing from the scope of the disclosure.

The abnormality detection system and the chiller, the abnormality detection method, and the abnormality detection program described in each of the embodiments described above are grasped, for example, as follows.

An abnormality detection system (50) according to the present disclosure includes: an acquisition unit (51) that acquires driving data of a target device; a model calculation unit (53) that creates a model capable of estimating a predetermined driving state of the target device based on the driving data, when the driving data is non-trained data; a determination unit (54) that compares an estimation value of the driving state, which is estimated by using the model, with an actual measurement value corresponding to the driving state and that determines whether the driving data is an outlier value; and an abnormality detection unit (55) that performs abnormality detection on the target device based on the model, when the driving data is determined not to be the outlier value.

According to the abnormality detection system (50) of the present disclosure, when the driving data, which is acquired from the target device, is non-trained data, a model is created based on the driving data. Thereafter, it is determined whether the driving data used to create the model is an outlier value (an abnormality value) by comparing the estimation value of the driving state, which is estimated by using the created model, and the actual measurement value. Thereafter, when it is determined that the driving data is not an outlier value, the abnormality detection of the target device is performed by using the created model. As a result, when non-trained driving data is acquired, it is possible to determine whether the driving data is an outlier value, and it is possible to perform the abnormality detection by using a model based on the driving data that is not an outlier value. Therefore, the accuracy of the abnormality detection can be improved.

In the abnormality detection system (50) according to the present disclosure, the determination unit (54) may determine whether the driving data is the outlier value based on an error between the estimation value and the actual measurement value, and an allowable error range.

According to the abnormality detection system (50) according to the present disclosure, it is possible to determine whether the driving data is an outlier value based on the error between the estimation value and the actual measurement value.

In the abnormality detection system (50) according to the present disclosure, the allowable error range may be set based on a measurement error of the actual measurement value.

According to the abnormality detection system (50) of the present disclosure, by setting the allowable error range based on the measurement error of the actual measurement value, it is possible to perform the determination process of the outlier value more effectively.

In the abnormality detection system (50) according to the present disclosure, a plurality of driving modes may be set in advance, the abnormality detection system (50) may further include a mode specification unit (52) that specifies the driving mode of the target device based on the driving data, the model calculation unit (53) may create the model in accordance with the specified driving mode, and the abnormality detection unit (55) may perform abnormality detection of the target device based on the model created in accordance with the specified driving mode.

According to the abnormality detection system (50) of the present disclosure, the driving mode of the target device is specified based on the driving data, the model is created in accordance with the specified driving mode, and the model is used for the abnormality detection. Therefore, it is possible to improve the accuracy of the abnormality detection.

In the abnormality detection system (50) according to the present disclosure, the driving mode may be at least any two of a stop state, an idling state, a low load state in which a load state is less than a first predetermined value, a driving state in which the load state is equal to or greater than the first predetermined value and less than a second predetermined value that is set to a value greater than the first predetermined value, and a high load state in which the load state is equal to or greater than the second predetermined value.

According to the abnormality detection system (50) of the present disclosure, since at least any two of the stop state, the idling state, the low load state, the driving state, and the high load state are set as the driving mode, the driving modes can be classified in accordance with a load condition. That is, the plurality of driving modes are set in advance, and one driving mode is selected based on the driving data.

In the abnormality detection system (50) according to the present disclosure, the target device may be a chiller that uses brine as a heat medium, and the driving mode may be at least any two of a stop state, an idling state, a state in which the chiller is being driven and a hot gas bypass valve (78), which makes some of gas that is compressed by a compressor (60) bypass to an inlet side of the compressor (60), is open, a state in which the chiller is being driven and the hot gas bypass valve (78) is closed, and a state in which the chiller is being driven, the hot gas bypass valve (78) is closed, and a target temperature of chilled water output from the chiller is higher than 0° C.

According to the abnormality detection system (50) of the present disclosure, since at least any two of the stop state, the idling state, the state in which the chiller is being driven and a hot gas bypass valve (78) is open, a state in which the chiller is being driven and the hot gas bypass valve (78) is closed, and a state in which the chiller is being driven, the hot gas bypass valve (78) is closed, and a target temperature of chilled water output from the chiller is higher than 0° C. are set as the driving mode, the driving modes can be classified in accordance with the change in the driving state of the chiller. That is, the plurality of driving modes are set in advance, and one driving mode is selected based on the driving data.

A chiller according to the present disclosure includes: a compressor (60); a condenser (62) for condensing a refrigerant compressed by the compressor (60); an expansion valve for expanding the condensed refrigerant; an evaporator (66) for evaporating the expanded refrigerant and cooling chilled water; and the above-mentioned abnormality detection system (50).

An abnormality detection method according to the present disclosure includes: a step of acquiring driving data of a target device; a step of creating a model capable of estimating a predetermined driving state of the target device based on the driving data, when the driving data is non-trained data; a step of comparing an estimation value of the driving state, which is estimated by using the model, with an actual measurement value corresponding to the driving state and determining whether the driving data is an outlier value; and a step of performing abnormality detection on the target device based on the model, when the driving data is determined not to be the outlier value.

An abnormality detection program according to the present disclosure for causing a computer to execute: a process of acquiring driving data of a target device; a process of creating a model capable of estimating a predetermined driving state of the target device based on the driving data, when the driving data is non-trained data; a process of comparing an estimation value of the driving state, which is estimated by using the model, with an actual measurement value corresponding to the driving state and determining whether the driving data is an outlier value; and a process of performing abnormality detection on the target device based on the model, when the driving data is determined not to be the outlier value.

### REFERENCE SIGNS LIST

1: Heat source system
3: Load
11˜13: Centrifugal chiller (chiller)
21˜23: Chilled water pump
31: Supply header
32: Return header
33: Bypass pipe
34: Bypass valve
50: Abnormality detection system
51: Acquisition unit
52: Mode specification unit
53: Model calculation unit
54: Determination unit
55: Abnormality detection unit
60: Compressor
62: Condenser
63: Sub cooler
64: High-pressure expansion valve (expansion valve)
65: Low-pressure expansion valve (expansion valve)
66: Evaporator
67: Economizer
70: Variable frequency drives
72: electric motor
74: Control panel
76: Hot gas bypass pipe
78: Hot gas bypass valve
79: Inlet guide vane (IGV)
80: Condenser tubes
82: Evaporator tubes
111: CPU
112: ROM
113: RAM
114: Hard disk drive
115: Communication unit
118: Bus

1. An abnormality detection system comprising:
an acquisition unit that acquires driving data of a target device;
a model calculation unit that creates a model capable of estimating a predetermined driving state of the target device based on the driving data, when the driving data is non-trained data;
a determination unit that compares an estimation value of the driving state, which is estimated by using the model, with an actual measurement value corresponding to the driving state and that determines whether the driving data is an outlier value; and
an abnormality detection unit that performs abnormality detection on the target device based on the model, when the driving data is determined not to be the outlier value.

2. The abnormality detection system according to claim 1, wherein
the determination unit determines whether the driving data is the outlier value based on an error between the estimation value and the actual measurement value, and an allowable error range.

3. The abnormality detection system according to claim 2, wherein
the allowable error range is set based on a measurement error of the actual measurement value.

4. The abnormality detection system according to claim 1, wherein
a plurality of driving modes are set in advance, the abnormality detection system further comprises a mode specification unit that specifies the driving mode of the target device based on the driving data,
the model calculation unit creates the model in accordance with the specified driving mode, and
the abnormality detection unit performs abnormality detection of the target device based on the model created in accordance with the specified driving mode.

5. The abnormality detection system according to claim 4, wherein
the driving mode is at least any two of a stop state, an idling state, a low load state in which a load state is less than a first predetermined value, a driving state in which the load state is equal to or greater than the first predetermined value and less than a second predetermined value that is set to a value greater than the first predetermined value, and a high load state in which the load state is equal to or greater than the second predetermined value.

6. The abnormality detection system according to claim 4, wherein
the target device is a chiller that uses brine as a heat medium, and
the driving mode is at least any two of a stop state, an idling state, a state in which the chiller is being driven and a hot gas bypass valve, which makes some of gas that is compressed by a compressor bypass to an inlet side of the compressor, is open, a state in which the chiller is being driven and the hot gas bypass valve is closed, and a state in which the chiller is being driven, the hot gas bypass valve is closed, and a target temperature of chilled water output from the chiller is higher than 0° C.

7. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 1.

8. An abnormality detection method comprising:
a step of acquiring driving data of a target device;
a step of creating a model capable of estimating a predetermined driving state of the target device based on the driving data, when the driving data is non-trained data;
a step of comparing an estimation value of the driving state, which is estimated by using the model, with an actual measurement value corresponding to the driving state and determining whether the driving data is an outlier value; and
a step of performing abnormality detection on the target device based on the model, when the driving data is determined not to be the outlier value.

9. An abnormality detection program for causing a computer to execute:
a process of acquiring driving data of a target device;
a process of creating a model capable of estimating a predetermined driving state of the target device based on the driving data, when the driving data is non-trained data;
a process of comparing an estimation value of the driving state, which is estimated by using the model, with an actual measurement value corresponding to the driving state and determining whether the driving data is an outlier value; and
a process of performing abnormality detection on the target device based on the model, when the driving data is determined not to be the outlier value.

10. The abnormality detection system according to claim 2, wherein
a plurality of driving modes are set in advance, the abnormality detection system further comprises a mode specification unit that specifies the driving mode of the target device based on the driving data,
the model calculation unit creates the model in accordance with the specified driving mode, and
the abnormality detection unit performs abnormality detection of the target device based on the model created in accordance with the specified driving mode.

11. The abnormality detection system according to claim 3, wherein
a plurality of driving modes are set in advance, the abnormality detection system further comprises a mode specification unit that specifies the driving mode of the target device based on the driving data,
the model calculation unit creates the model in accordance with the specified driving mode, and
the abnormality detection unit performs abnormality detection of the target device based on the model created in accordance with the specified driving mode.

12. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 2.

13. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 3.

14. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 4.

15. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 5.

16. A chiller comprising:
a compressor;
a condenser for condensing a refrigerant compressed by the compressor;
an expansion valve for expanding the condensed refrigerant;
an evaporator for evaporating the expanded refrigerant and cooling chilled water; and
the abnormality detection system according to claim 6.
